(19) United States
(12) Patent Application Publication
(10) Pub. No.: US 2007/0029748 A1
(43) Pub. Date: Feb. 8, 2007

(54) Steering system

(75) Inventors: John Baxter, Chatswood (AU); Andrew James Heathershaw, Leichhardt (AU)

Correspondence Address: BIRCH STEWART KOLASCH & BIRCH, PO BOX 747, FALLS CHURCH, VA, 22040-0747, US

(73) Assignee: BISHOP INNOVATION LIMITED, North Ryde (AU)

(21) Appl. No.: 10/572,056

(22) PCT Filed: Oct. 14, 2004
(86) PCT No.: PCT/AU04/01394

§ 371 Date: Oct. 17, 2006

(30) Foreign Application Priority Data
Oct. 14, 2003 (AU) 2003905623

(51) Int. Cl. B60G 21/10; B60G 7/02; B62D 7/16

(52) U.S. Cl. 280/86.758; 280/93.51; 280/5.51

(57) ABSTRACT

A steering system for a vehicle comprising a steering gear (10) having a rack (12) and a pinion (14) in mesh therewith. The rack (12) being laterally displaceable with respect to the vehicle as a function of inputs from a steering wheel (24) through rotation of the pinion (14), and a steering superposition means (32). The steering system further comprising first and second road wheels (20a, 20b) steerable by rotation of first and second steering arms (21a, 21b) respectively by means of first and second tie rods (15a, 15b) arranged to transmit lateral displacement of the rack (12) to the first and second steering arms (21a, 21b) respectively. Lateral displacement of the rack (12) being transmitted to at least one of the steering arms (21a, 21b) through a linear actuator (25). The linear actuator (25) and the steering superposition means (32) being controlled by a control means (30) in response to at least one sensed parameter (31).

### TECHNICAL FIELD

The present invention relates to a steering system for a vehicle and in particular to a means of actively varying the toe angle of the steerable road wheels.

### BACKGROUND

Recently there has been much interest in steering superposition systems where a supplementary steering input can be made to the steering angle of the front wheels by a device which receives inputs from sensed parameters, typically steering wheel angular input from the driver and/or the vehicle speed, resulting in an output from the steering gear which is effectively the sum of the drivers steering wheel input and the input from the superposition device.

A large number of these systems use a planetary gear box and a controlled electric motor to provide additional input to the steering gear. Such a system is described in U.S. Pat. No. 3,831,701 (Pilon et al). In this case, the steering gear is of the recirculating ball type and a planetary gearbox provides additional rotation of the worm. The same principle is applied to rack and pinion steering gears where a planetary gearbox provides additional rotation of the pinion that meshes with the rack. Other systems, such as the device described in WO 02/36410, achieve the supplementary steering input by moving the pinion substantially in the direction of the rack travel.

These superposition devices enable the steering angle of the steerable road wheels to be actively varied, independent of the driver's steering wheel input. However, the nature of these devices mean that the toe angle of the steerable road wheels necessarily remains fixed.

Toe angle is a term used in the automotive industry to define the angular difference in plan view between the steerable road wheels. It is commonly expressed as the difference in distance between the fronts and rears of the wheel rims when the steerable wheels are in the straight ahead position. However, for simplicity in this specification, it will be expressed as angular difference. Positive toe angle, known as toe-in, is where the front of each of the steerable wheels are closer to each other than the rear. The toe angle of most steering systems is fixed to a predetermined value during vehicle assembly or servicing by manually adjusting the length of the tie rods that connect the steering gear to the steering arms.

Steering offset angle is defined in this specification as the angle of the steering wheel, with respect to the centred position of the steering wheel, when the steerable road wheels are in their on-centre position. The on-centre position of the steerable road wheels occurs when the toe-in angle between these wheels is equally distributed about the longitudinal axis of the vehicle, and unless there are any disturbances or road camber the vehicle will be running substantially straight ahead. For example, if zero toe angle is employed, the on-centre position of the steerable road wheels will align with the longitudinal axis of the vehicle. If the steering wheel angle position in this situation is 4.7 deg clockwise from its centred position, then the steering offset angle is defined as being +4.7 deg. For vehicles without steering superposition devices, the steering offset angle is fixed and is usually simultaneously adjusted during vehicle assembly or servicing with the toe angle. Typically, for a conventional steering system, the steering offset angle is set to zero (within a given setting tolerance) and the toe angle is usually set to either zero or a small positive or negative angle (typically in the range −0.5 deg to +0.5 deg).

The steering superposition devices discussed above, when used without any other active steering control means, effectively just vary the steering offset angle. There is a strong motivation, from the point of view of optimizing the vehicle dynamics, to actively vary the steering offset angle during driving. Varying the steering offset angle can be used to counteract the effect of yaw moments acting on the vehicle due to transient cross winds, road camber, and mismatches between the tyre friction characteristics between the left- and right-hand sides of the vehicle. Actively varying the steering offset angle can render these external disturbances much less noticeable to the driver, and hence dramatically improve the vehicle stability.

Also from the point of view of optimizing the dynamics of the vehicle, there is a strong motivation to actively vary the steering ratio during driving. Steering ratio is a term used in the automotive industry to define the ratio between angular movement of the steering wheel and the average angular movement of the two (usually front) steerable road wheels. For low speed driving a low (direct) steering ratio should ideally be employed to increase the manoeuvrability of the vehicle and decrease the lock-to-lock steering turns required for parking manoeuvres. For high speed driving a much higher (less direct) steering ratio should be employed to decrease the (otherwise) excessive yaw response of the vehicle. This increase in steering ratio should be employed at least in the “on-centre” operating region of the steering system associated with high speed driving. However, it is preferable that the steering ratio can be varied throughout the range of movement of the steering gear. Active control of the steering ratio can be achieved by using a steering superposition device to continually vary the steering offset angle.

It is well known that the relationship between the angles through which a pair of steerable road wheels turn should ideally follow the Ackermann principle. Ackermann proposed a relationship between the inner and outer front steerable road wheels during a turn, based on zero tyre slip, such that lines drawn through axes of the two wheels in plan view intersect at the same point on a line extended longitudinally from the rear axle. However this does not necessarily result in the appropriate relationship between the steerable road wheels when the tyres generate slip or the wheels are displaced vertically or horizontally due to road inputs. This can lead to accelerated tyre wear, irregular force feedback and reduced handling potential which may compromise vehicle safety. Furthermore, it is well known that a conventional steering system theoretically only achieves true Ackermann for one steering angle. Actively varying the toe angle can overcome these problems and several methods have been proposed to achieve this, as discussed below.

U.S. Pat. No. 4,371,191 (Goldberg et al), U.S. Pat. No. 5,143,400 (Miller et al) and JP 9-193827 (Yukimitsu et al) all disclose steering systems having hydraulic cylinders integrated with, or in line with, both tie rods. The hydraulic cylinders are controlled to effectively vary the length of the tie rods and hence actively vary the toe angle. These systems can also be controlled to actively vary the steering offset angle. However, the range of variation in steering offset angle is limited by the constraints of packaging the cylinders in line with the tie rods and hence it is difficult for such systems to provide large variations in steering ratio over the range of movement of the steering gear, particularly in comparison with the variation in steering ratio achievable by steering superposition devices having a planetary gearbox. Also, such systems must have actuators in both tie rods in order that the toe angle can be varied without the necessity of simultaneously varying the steering offset angle.

Heavy vehicles typically have a steering system with a single tie rod connecting both steering arms and a steering gear that is arranged to rotate one of the steering arms directly. U.S. Pat. No. 6,283,483 (Johnson et al) discloses a modification to such a steering system where a hydraulic cylinder is integrated with the single tie rod to actively vary its length. This system can actively vary the toe angle but it has the disadvantage that any variation in toe angle also results in a variation of the steering offset angle. For example, if the toe angle is actively varied whilst the vehicle is running in a straight line then the driver must correct the steering wheel angle to maintain straight ahead running.

It is an object of the present invention to ameliorate at least some of the problems of the prior art.

### SUMMARY OF INVENTION

The present invention consists of a steering system for a vehicle comprising a steering gear having a rack and a pinion in mesh therewith, said rack being laterally displaceable with respect to said vehicle as a function of inputs from a steering wheel through rotation of said pinion, and a steering superposition means, and first and second road wheels steerable by rotation of first and second steering arms respectively by means of first and second tie rods arranged to transmit lateral displacement of said rack to said first and second steering arms respectively, characterised in that lateral displacement of said rack is transmitted to at least one of said steering arms through a linear actuator, and said linear actuator and said steering superposition means are controlled by a control means in response to at least one sensed parameter.

Preferably, lateral displacement of said rack is transmitted to only one of said steering arms through a linear actuator.

Preferably, said linear actuator is integrated with one of said tie rods. Preferably, there is a pivot joint at each end of said tie rod and said linear actuator is disposed between said pivot joints.

Preferably, said linear actuator comprises a ball screw assembly. Preferably, said linear actuator further comprises a hollow armature electric motor.

Preferably, in one embodiment, said steering superposition means provides rotation of said pinion in addition to that provided by said steering wheel. Preferably, said steering wheel is connected to a steering column and said steering superposition means is integrated with said steering column. Alternatively, said steering superposition means is integrated with said steering gear.

Preferably, in another embodiment, said steering superposition means provides lateral displacement of said pinion. Preferably, said steering superposition means is integrated with said steering gear.

Preferably, said linear actuator and said steering superposition means may be controlled such that the toe angle of said road wheels is variable without varying the steering offset angle.

Preferably, said sensed parameter comprises steering wheel rotation. Preferably, said sensed parameter comprises vehicle speed.

### BRIEF DESCRIPTION OF DRAWINGS

The present invention will now be described by way of example with reference to the accompanying drawings, in which:

FIG. 1 is a schematic of a first embodiment of a steering system for a vehicle in accordance with the present invention, where only one linear actuator is used in conjunction with a steering superposition device.

FIG. 2a shows the tie-rod and integrated linear actuator of the steering system of FIG. 1.

FIG. 2b shows an alternative arrangement for integrating a tie rod and linear actuator for a steering system in accordance with the present invention.

FIG. 3 shows a sectional view of the linear actuator of FIG. 2b.

FIG. 4a shows how the toe angle is adjusted during straight ahead running without changing the steering offset angle, using the steering system of FIG. 1.

FIG. 4b shows how the steering offset angle and toe angle are adjusted to correct for disturbances using the steering system of FIG. 1.

FIG. 4c shows how toe angle can be optimised during cornering for each steerable road wheel, using the steering system of FIG. 1.

FIG. 5a shows how the turn radius is determined for a vehicle using a typical prior art Ackermann steering arrangement.

FIG. 5b shows how the turn radius of a vehicle can be minimized by using a steering system according to the present invention.

FIG. 6 shows how toe angle can be adjusted during braking on split-μ surfaces using a steering system according to the present invention.

FIG. 7 is a schematic of a second embodiment of a steering system for a vehicle in accordance with the present invention, where two linear actuators are used in conjunction with a steering superposition device.

For the sake of brevity and descriptive convenience in the following description, functionally similar components appearing in more than one figure bear common reference numerals in all of the figures, and their initial description made in respect to an earlier figure is generally not repeated in relation to a later figure.

### BEST MODE OF CARRYING OUT THE INVENTION

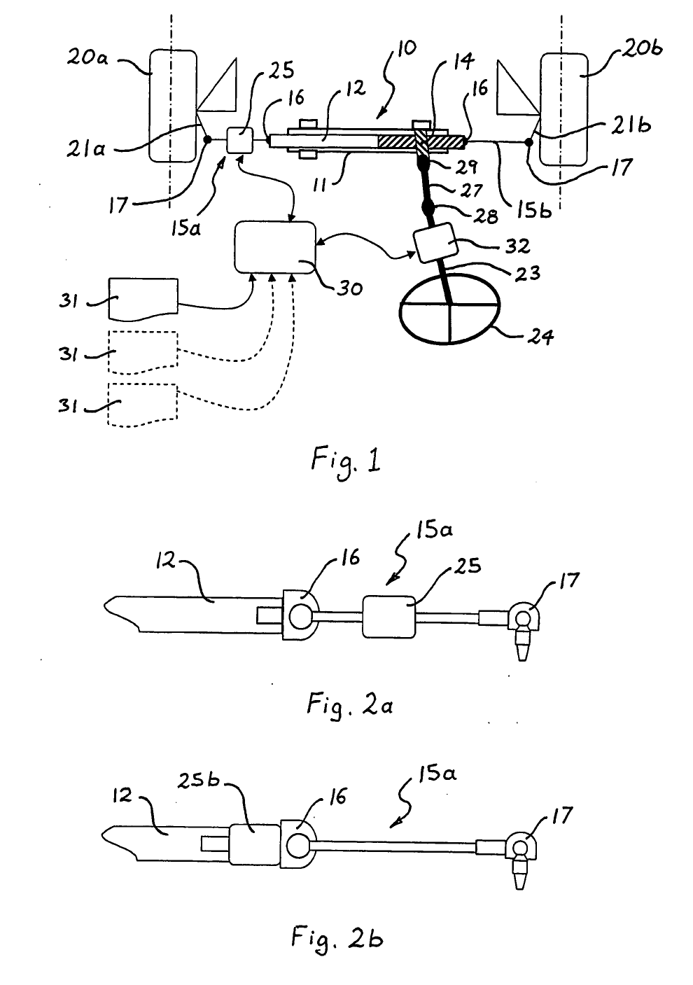

FIG. 1 is a schematic of a first embodiment of a steering system for a vehicle in accordance with the present invention, where only one linear actuator is used in conjunction with a steering superposition device. Steering gear 10 is of the conventional rack and pinion type, and comprises a rack 12 laterally displaceable within a housing 11 that is mounted to the vehicle. Pinion 14 meshes with rack 12 such that rotation of pinion 14 laterally displaces rack 12.

Steering input is applied by the driver through rotation of steering wheel 24, which is connected to steering column 23. Steering superposition device 32 is integrated with steering column 23 and its output is rotationally transmitted to pinion 14 through hookes joints 28, 29 and intermediate shaft 27. Steering superposition device 32 adds incremental rotation of pinion 14 to that provided by rotation of steering wheel 24, and therefore steering superposition device 32 provides incremental lateral displacement of rack 12. Steering superposition device 32 may utilise a planetary gearbox controlled by an electric motor. Such steering superposition devices are well known in the prior art, as discussed in the background. A hydraulic power steering valve or a torque sensor, depending on whether steering gear 10 is respectively a hydraulically power assisted or an electrically power assisted steering gear, would normally be connected upstream of pinion 14 and would typically form part of steering gear 10.

This valve or sensor may either be upstream or downstream of the steering superposition device. For simplicity in this description, no valves, torque sensors or power assistance means are shown.

It should be noted that steering systems in accordance with the present invention may use other types of steering superposition devices to that shown in FIG. 1. For example, known devices that laterally move the pinion or known devices integrated with the steering gear that provide additional pinion rotation may be used. The important feature being that the steering superposition device provides additional incremental lateral displacement of the rack to that provided by rotation of the steering wheel.

It should also be noted that means other than hookes joints 28, 29 and intermediate shaft 27 may be used to transmit rotation from steering column 23 to pinion 14. For example, one or both the hookes joints may substituted for a rag joint or a simple non-compliant metal sleeve arrangement. Alternatively the entire connection member may comprise a simple non-compliant metal sleeve member which enables direct rotational connection of steering column 23 to pinion 14.

Road wheels 20a and 20b are mounted on hub assemblies (not shown) that each pivot about a substantially vertical axis. Steering arms 21a and 21b are attached to the hub assemblies. Road wheels 20a and 20b are steered by rotation of steering arms 21a and 21b respectively. Tie-rods 15a and 15b are connected to steering arms 21a and 21b respectively by outer pivot joints 17, and are connected to the ends of rack 12 through inner pivot joints 16. Tie-rods 15a and 15b transmit the lateral displacement of rack 12 to steering arms 21a and 21b thereby steering road wheels 20a and 20b.

Tie-rod 15b is a conventional solid tie rod that transmits displacement of rack 12 directly to steering arm 21b. Tie-rod 15a, however, has linear actuator 25 integrated with it such that the length of tie-rod 15a is variable. FIG. 2a shows the arrangement of tie-rod 15a in more detail. In this case, linear actuator 25 is disposed between pivot joints 16 and 17. FIG. 2b shows an alternative arrangement for integrating a linear actuator with tie rod 15a. In this case linear actuator 25b is positioned between inner pivot joint 16 and rack 12. Linear actuator 25b thus still effectively varies the length of tie-rod 15a.

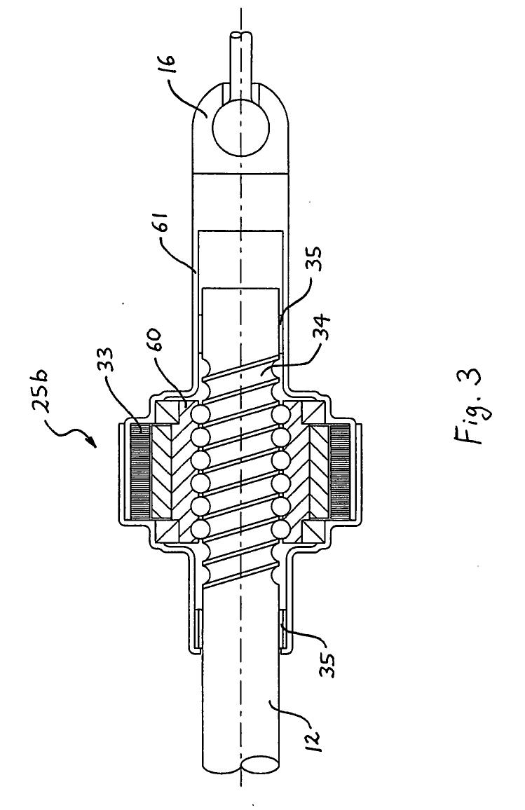

FIG. 3 is a longitudinal cross-section of linear actuator 25b. Linear actuator 25b comprises a hollow armature electric motor 33 rotating a ball nut 60, and the end of rack 12 has a corresponding ball screw 34. Motor 33 would typically include a rotational position sensor to facilitate closed-loop control of its position and may also incorporate a force sensor for measuring axial forces in tie-rod 15a. Rotation of ball nut 60 causes the body 61 of linear actuator 25b to move axially with respect to rack 12. Linear actuator body 61 is supported by rack 12 through sliding bearings 35. Body 61 is keyed against rotation with respect to rack 12 by means not shown. Such devices are well known in the field of mechatronics, and are typical of those used to servo control the position of aerodynamic control surfaces on modern aircraft. Linear actuator 25, shown schematically in FIGS. 1 and 2a, may have a similar construction to linear actuator 25b.

An advantage of having only one tie rod integrated with a linear actuator, compared with the prior art that has linear actuators in both tie rods, is that it is easier to package in the limited space available in a vehicle for the steering system.

Referring again to FIG. 1, control unit 30 receives input from at least one sensed parameter 31 and closed-loop controls the positions of linear actuator 25 and steering superposition device 32 according to mechatronic principles well known in the art of steering systems. Alternatively, separate control units may be used to control linear actuator 25 and steering device superposition device 32. However, in this case the control units must communicate with each other and as such are still effectively a single control means. Still alternatively, control unit 30 may be incorporated into the main steering electronic control unit (ECU) or even the chassis ECU. Parameter(s) 31 may include steering wheel rotation and/or vehicle speed.

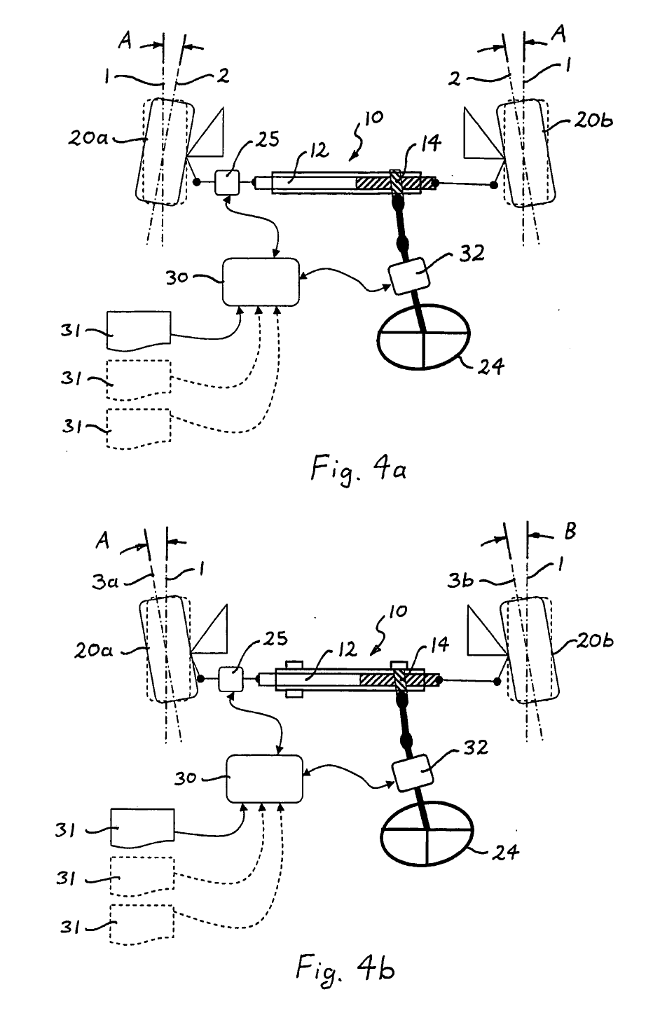

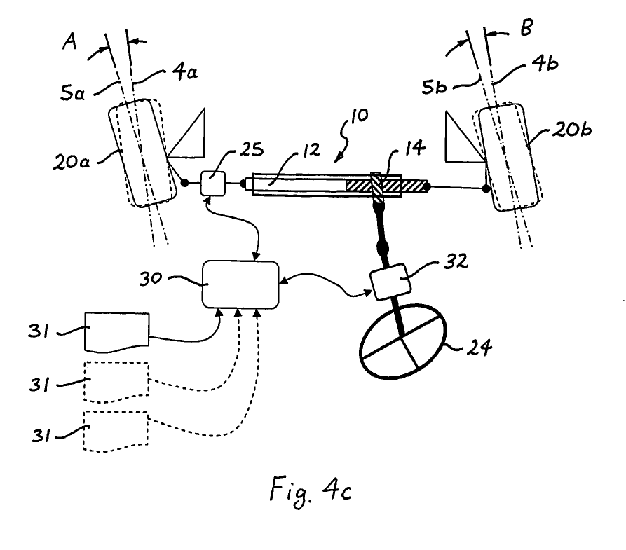

FIGS. 4a, 4b and 4c explain the operation of the steering system shown in FIG. 1. FIG. 4a shows how toe angle is adjusted during straight ahead running without changing the steering offset angle. Lines 1 indicate the angular dispositions of road wheels 20a and 20b when the vehicle is travelling in the straight ahead direction, under ideal conditions, with zero toe angle. Lines 2 indicate the angular dispositions of road wheels 20a and 20b when the vehicle is travelling in the straight ahead direction with positive toe angle (ie. toe-in). The angle A between lines 1 and 2 is equal on both sides. To actively vary the toe angle from zero to a positive toe angle as shown, the control unit 30 commands the steering superposition device 32 and the linear actuator 25 to actuate simultaneously. Steering superposition device 32 outputs a counter-clockwise incremental rotation of pinion 14, which laterally moves rack 12 incrementally to the right thus turning road wheel 20b inwards by angle A (ie. from angular disposition 1 to 2). At the same time, linear actuator 25 extends by an amount equal to twice the incremental lateral displacement of rack 12 thus also turning road wheel 20a inwards by angle A. It is important to note that during this change in toe angle the steering offset angle has not varied and there is no incremental rotation of steering wheel 24. This solves the problem of varying the toe angle using a linear actuator on only one tie-rod without a steering superposition device. In this case, if the toe angle was varied by extending the linear actuator then the driver would have to rotate the steering wheel to keep the vehicle travelling straight ahead, which is undesirable. Whilst FIG. 4a shows an example where the toe angle is varied from zero to positive, the same control method can be equally be applied to vary the toe angle to a negative value (toe-out).

FIG. 4b shows how the steering offset angle and toe angle are actively varied, without driver input, to keep the vehicle travelling straight ahead when encountering an external disturbance such as road camber irregularities or cross winds. Before encountering the disturbance, the angular dispositions of road wheels 20a and 20b are indicated by lines 1. In this example, to maintain straight ahead running during the disturbance it is desired to rotate road wheels 20a and 20b by angles A and B counter-clockwise respectively, as indicated by lines 3a and 3b. To achieve this correction, steering superposition device 32 outputs a counter-clockwise incremental rotation of pinion 14, which laterally moves rack 12 incrementally to the right thus turning road wheel 20b inwards by angle B. At the same time, linear actuator 25 extends by an incremental amount, as required, to create the desired difference in angular disposition between road wheels 20a and 20b. The extension of linear actuator 25 is proportional to the difference between angles A and B. Therefore, the toe angle has varied by the difference between angles A and B. Steering wheel 24 has not been rotated by the driver, so the steering offset angle has effectively varied by the average of angles A and B.

FIG. 4c shows how toe angle can be optimised for each road wheel during cornering. In this example the driver has rotated steering wheel 24 such that road wheels 20a and 20b have angular dispositions 4a and 4b respectively. In this example it is desired to incrementally rotate road wheels 20a and 20b by angles A and B counter-clockwise respectively, as indicated by lines 5a and 5b. To achieve this correction, steering superposition device 32 outputs a counter-clockwise incremental rotation of pinion 14, which laterally moves rack 12 incrementally to the right thus turning road wheel 20b inwards by angle B. At the same time, linear actuator 25 extends by an incremental amount required to create the difference in angular disposition of road wheels 20a and 20b equal to the difference between A and B. Therefore, the toe angle has varied by the difference between angles A and B. During this correction, steering wheel 24 has not been rotated by the driver, so the steering offset angle has effectively varied by the average of angles A and B.

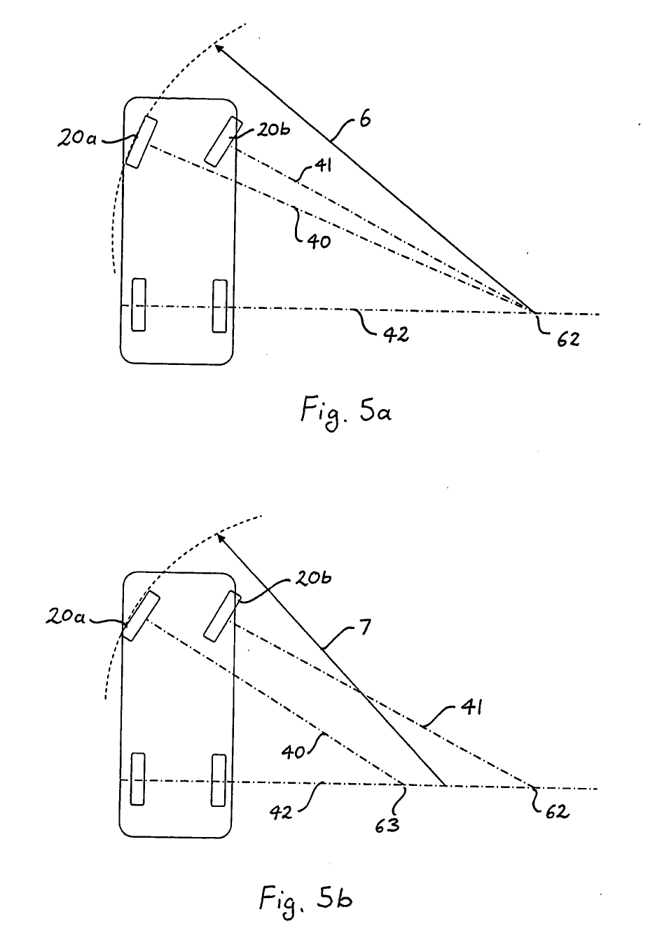

FIGS. 5a and 5b show how individually varying the toe angle of the steerable wheels, such as shown in FIG. 4c, can be used to reduce the minimum turning circle radius of a vehicle. FIG. 5a shows the minimum turning circle radius 6 of a vehicle with conventional Ackermann steering where lines 40 and 41 passing through the axes of steerable road wheels 20a and 20b intersect line 42, passing through the axis of the rear wheels, at approximately the same point 62. In FIG. 5b, steerable road wheel 20a has been further rotated by linear actuator 25 (not shown in this figure) extending such that line 40 passing through the axis of road wheel 20a now intersects line 42 at point 63, which is closer to the vehicle than point 62. The resulting effective turning circle radius 7, centred between points 62 and 63, is less than radius 6.

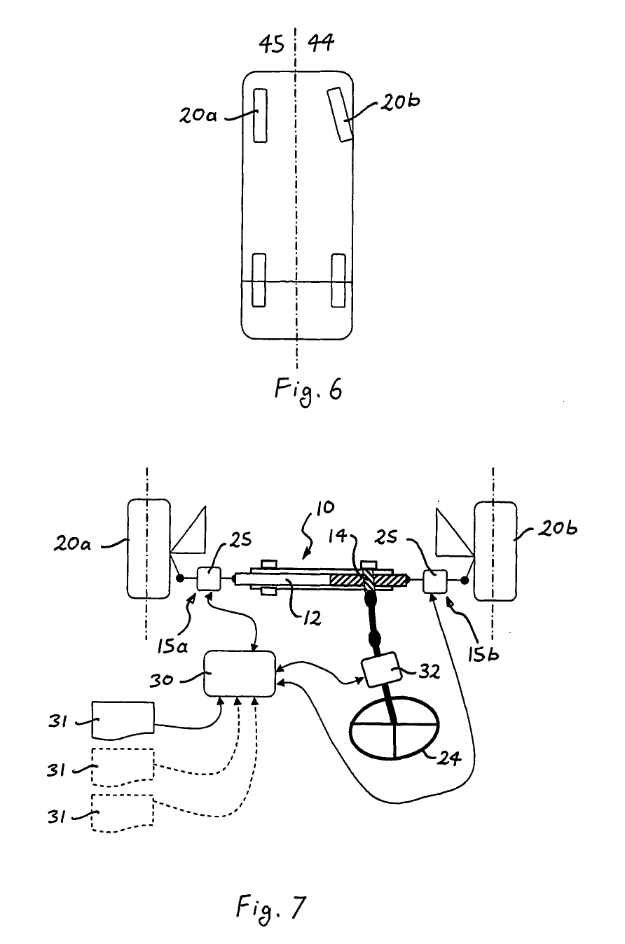

FIG. 6 shows a further application of the present invention, which is to stabilise a vehicle during braking on a “split-μ” surface (ie. a non-homogenous surface with different level of tyre adhesion between the left-hand tyres and the right-hand tyres).

An example of this condition is when half of the vehicle is on a high-μ surface 44 such as dry bitumen, and the other half of the vehicle is on a low-μ surface 45 such as gravel or ice. It is well known in the art of vehicle dynamics that, during braking on this split-μ surface, there is an inherent compromise between maintaining stability of the vehicle and achieving a minium stopping distance. This is a result of the fact that the road wheel which is on the high-μ surface generates a higher braking force which creates a yaw moment which turns the vehicle towards the high-μ surface. The present invention enables the steer angle of each steerable wheel to be actively modified individually such that a high brake force can be applied to both steerable wheels without creating an unstable yaw moment on the vehicle. This is achieved as described with reference to FIG. 4b. In the example shown in FIG. 6, road wheel 20a on the low-μ surface 45 is kept pointing straight ahead, whilst road wheel 20b on the high-μ surface 44 is turned inwards.

FIG. 7 is a schematic of a second embodiment of a steering system for a vehicle in accordance with the present invention. The only difference this steering system and that shown in FIG. 1 is that the steering system in FIG. 7 has a linear actuator 25 integrated with each of tie-rods 15a and 15b. This additional linear actuator may be utilised to provide more range for variation of steering offset angle on top of that provided by steering superposition device 32. To achieve this, one linear actuator 25 can be extended whilst the other one is contracted. This additional means of varying steering offset angle may allow the steering offset angle to be varied faster than would be possible by using steering superposition device 32 alone. The speed at which steering superposition device 32 can vary the steering offset angle is limited by the power capacity of the power assistance means (whether hydraulic or electric), and the power capacity of the steering superposition device itself.

It should be understood that the present invention can also be applied to “centre take-off” steering gears where the tie-rods are attached to the rack near its middle, rather than its ends.

Although the present invention has been described in various embodiments in this specification, it should be recognised that departures may be made from the embodiments without departing from the scope of the invention.

The term “comprising” as used in this specification is used in the inclusive sense of “including” or “having”, and not in the exclusive sense of “consisting only of”.

1. A steering system for a vehicle comprising a steering gear having a rack and a pinion in mesh therewith, said rack being laterally displaceable with respect to said vehicle as a function of inputs from a steering wheel through rotation of said pinion and a steering superposition means operable on said pinion, and first and second road wheels steerable by rotation of first and second steering arms respectively by means of first and second tie rods arranged to transmit lateral displacement of said rack to said first and second steering arms respectively, characterised in that lateral displacement of said rack is transmitted to at least one of said steering arms through a linear actuator, and said linear actuator and said steering superposition means are controlled by a control means in response to at least one sensed parameter.

2. A steering system as claimed in claim 1 wherein lateral displacement of said rack is transmitted to only one of said steering arms through a linear actuator.

3. A steering system as claimed in claim 1 wherein said linear actuator is integrated with one of said tie rods.

4. A steering system as claimed in claim 3 wherein there is a pivot joint at each end of said tie rod and said linear actuator is disposed between said pivot joints.

5. A steering system as claimed in claim 1 wherein said linear actuator comprises a ball screw assembly.

6. A steering system as claimed in claim 5 wherein said linear actuator further comprises a hollow armature electric motor.

7. A steering system as claimed in claim 1 wherein said steering superposition means provides rotation of said pinion in addition to that provided by said steering wheel.

8. A steering system as claimed in claim 7 wherein said steering wheel is connected to a steering column and said steering superposition means is integrated with said steering column.

9. A steering system as claimed in claim 1 wherein said steering superposition means provides lateral displacement of said pinion.

10. A steering system as claimed in claims 7 wherein said steering superposition means is integrated with said steering gear.

11. A steering system as claimed in claim 1 wherein said linear actuator and said steering superposition means may be controlled such that the toe angle of said road wheels is variable without varying the steering offset angle.

12. A steering system as claimed in claim 1 wherein said sensed parameter comprises steering wheel rotation.

13. A steering system as claimed in claim 1 wherein said sensed parameter comprises vehicle speed.

14. A steering system as claimed in claim 9 wherein said steering superposition means is integrated with said steering gear.
